(19) United States
(12) Patent Application Publication
(10) Pub. No.: US 2026/0124577 A1
(43) Pub. Date: May 7, 2026

(54) OZONE REDUCTION DEVICE

(71) Applicant: Finesse Technology Co., Ltd., Hsinchu County (TW)

(72) Inventors: SHIN-HUA TSENG, Hsinchu County (TW); YU-JUNG LIN, Hsinchu County (TW)

(73) Assignee: Finesse Technology Co., Ltd., Hsinchu County (TW)

(21) Appl. No.: 18/967,015

(22) Filed: Dec. 3, 2024

(30) Foreign Application Priority Data
Nov. 4, 2024 (TW) 113211954

(51) Int. Cl. B01D 53/66; B01D 53/34; B01D 53/76

(52) U.S. Cl. CPC B01D 53/66; B01D 53/346; B01D 53/76; B01D 2257/106; B01D 2258/0216

(57) ABSTRACT

Disclosed is an ozone reduction device used to reduce an ozone provided by an ozone source into an oxygen. The ozone reduction device comprises a gas inlet duct, a gas delivery tube, a heating element and a gas outlet duct. The gas inlet duct is communicated to the ozone source. The gas delivery tube introduces the ozone provided by the ozone source through the gas inlet duct, and the gas delivery tube transports the ozone along a spiral delivery path. The heating element is used to provide a thermal energy to heat the ozone transported by the gas delivery tube, so that the ozone is heated by the thermal energy and reduced to an oxygen when flowing along the spiral delivery path. The gas outlet duct is communicated to the gas delivery tube and used to discharge the oxygen obtained by reducing the ozone.

### CROSS-REFERENCE TO RELATED APPLICATION

This application claims priority from Taiwan Patent Application No. 113211954, filed on Nov. 4, 2024, each of which is hereby incorporated herein by reference in its entireties.

### BACKGROUND OF THE DISCLOSURE

### 1. Field of Disclosure

The disclosure relates to the technical field of ozone treatment, more particularly to an ozone reduction device capable of rapidly reducing ozone to oxygen by heating.

### 2. Related Art

Ozone can effectively clean the surfaces of semiconductor wafers, such as photoresist residues. In addition to cleaning, ozone has also been found to be capable of growing an oxide layer that can be used as a passivation layer or an interface layer for semiconductor devices. Because ozone has extremely poor stability and can be decomposed into oxygen at room temperature, ozone cannot be stored. Ozone is generally produced on-site using an ozone generator and used immediately.

However, ozone is a gas that is harmful to the human body and the environment. Although ozone can be decomposed into oxygen in the natural environment, this natural decomposition is very slow, so the ozone exhaust gas requires further treatment before it can be discharged.

Although there is currently ozone reduction technology that can decompose ozone into oxygen, the half-life of ozone is about 3 days at 20 degrees Celsius, and the half-life will decrease as the temperature increases. When the temperature reaches 250 degrees Celsius, the half-life is approximately 1.5 seconds. Most of the tail gas ozone decomposition devices of conventional ozone generators use thermal decomposition. Generally, ozone reduction technology comprises two steps: the first step is to install a heating element in the ozone reduction chamber; the second step is to introduce ozone into the ozone reduction chamber, so that the heating element heats the ozone and reduces it to oxygen. However, the conventional ozone reduction chamber is in a straight cylindrical shape, so the time for ozone gas to pass through the straight cylindrical ozone reduction chamber is quite short. Furthermore, in order to completely reduce ozone to oxygen, conventional technology must provide a very high temperature (approximately 420 degrees Celsius) to achieve this effect. Furthermore, in conventional ozone reduction technology, ozone is in direct contact with the heating element, which will lead to corrosion of the heating element.

### SUMMARY OF THE DISCLOSURE

In view of the above problem, an object of the disclosure is to provide an ozone reduction device capable of solving the above-mentioned problem of conventional ozone reduction technology.

In order to achieve the above object, the disclosure discloses an ozone reduction device for reducing an ozone provided by an ozone source into an oxygen, comprising: a gas inlet duct communicated to the ozone source; a gas delivery tube used for introducing the ozone provided by the ozone source through the gas inlet duct, the gas delivery tube transports the ozone along a spiral delivery path; a heating element used for providing a thermal energy to heat the ozone transported by the gas delivery tube, so that the ozone is heated by the thermal energy and reduced to the oxygen during a flowing process along the spiral delivery path; and a gas outlet duct communicated to the gas delivery tube and used to discharge the oxygen obtained by reducing the ozone.

Preferably, the gas delivery tube is a spiral tube, and the gas delivery tube is spirally provided on the heating element.

Preferably, the gas delivery tube is a spiral quartz tube, and the spiral quartz tube is sleeved on an exterior of the heating element.

Preferably, the heating element directly heats only the ozone in the gas delivery tube, simultaneously heats the gas delivery tube and the ozone in the gas delivery tube, and/or indirectly heats the ozone in the gas delivery tube by heating the gas delivery tube.

Preferably, the ozone reduction device of the disclosure further comprises a heat insulation element, the heat insulation element coating one or more than one of the gas delivery tube, the heating element, the gas inlet duct and/or the gas outlet duct, thereby maintaining a heating temperature of the ozone.

Preferably, the heat insulation element is a ceramic fiber thermal insulation foam.

Preferably, the ozone reduction device of the disclosure further comprises a thermometer for measuring a heating temperature of the thermal energy provided by the heating element for the ozone in the gas delivery tube.

Preferably, the ozone reduction device of the disclosure further comprises a temperature control element for controlling the heating element to provide the thermal energy according to the heating temperature measured by the thermometer, thereby heating the ozone to a preset temperature.

Preferably, the ozone reduction device of the disclosure further comprises a gas inlet end adapter and a gas outlet end adapter, the gas inlet end adapter being connected between the gas inlet duct and the gas delivery tube, and the gas outlet end adapter being connected between the gas delivery tube and the gas outlet duct.

Preferably, structures of the gas inlet end adapter and/or the gas outlet end adapter are Teflon coated with stainless steel.

Preferably, the ozone reduction device of the disclosure further comprises a cooling device, the cooling device being provided on the gas outlet duct or between the gas delivery tube and the gas outlet duct for lowering a temperature of the oxygen discharged from the gas delivery tube.

Preferably, the heating element is a ceramic heating tube.

Based on the above, the ozone reduction device of the disclosure can have one or more than one of the following advantages:
(1) By using the spiral gas delivery tube, such as a spiral quartz tube, as an ozone reduction chamber, an occupied space is smaller than that of the conventional straight-cylindrical ozone reduction chamber and a heat transfer area can be increased, capable of ensuring that ozone molecules flowing into the spiral gas delivery tube have sufficient heating time.
(2) The gas delivery tube is spirally sleeved on an exterior of the heating element, so that the heating element is located inside the spiral gas delivery tube, capable of providing better heating efficiency than conventional technology, thereby achieving an efficacy of reducing costs.
(3) The use of a heat insulation element is capable of further ensuring uniform heating temperature and avoiding rapid drop in temperature.
(4) Using the spiral gas delivery tube as an ozone reduction chamber is capable of avoiding corrosion of the heating element caused by direct ozone contact with the heating element in conventional technology.
(5) Ozone gas can be quickly reduced to oxygen, so the disclosure is very suitable for using in large-flow ozone gas reduction.

In order to enable the examiner to have a further understanding and recognition of the technical features of the disclosure, preferred embodiments in conjunction with detailed explanation are provided as follows.

### BRIEF DESCRIPTION OF THE DRAWINGS

FIG. 1 is a schematic diagram of an ozone reduction device of the disclosure.

FIG. 2I and FIG. 2II are schematic diagrams of combination of a gas delivery tube and a heating element of the ozone reduction device of the disclosure, in which FIG. 2I is a schematic diagram before assembly, and FIG. 2II is a schematic diagram after assembly.

FIG. 3 is a schematic diagram of an ozone reduction experimental equipment used in the ozone reduction device of the disclosure.

FIG. 4 is a 10-second measurement chart of an ozone reduction experiment of the ozone reduction device of the disclosure.

FIG. 5 is a 30-second measurement chart of the ozone reduction experiment of the ozone reduction device of the disclosure.

### DETAILED DESCRIPTION OF THE DISCLOSURE

In order to understand the technical features, content and advantages of the disclosure and its achievable efficacies, the disclosure is described below in detail in conjunction with the figures, and in the form of embodiments, the figures used herein are only for a purpose of schematically supplementing the specification, and may not be true proportions and precise configurations after implementation of the disclosure; and therefore, relationship between the proportions and configurations of the attached figures should not be interpreted to limit the scope of the claims of the disclosure in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present disclosure will be defined below or in other parts of the descriptions as an extra guidance for those skilled in the art to understand the descriptions of the present disclosure.

The terms such as “first”, “second”, “third” and “fourth” used in the descriptions are not indicating an order or sequence, and are not intending to limit the scope of the present disclosure. They are used only for differentiation of components or operations described by the same terms.

Moreover, the terms “comprising”, “including”, “having”, and “with” used in the descriptions are all open terms and have the meaning of “comprising but not limited to”.

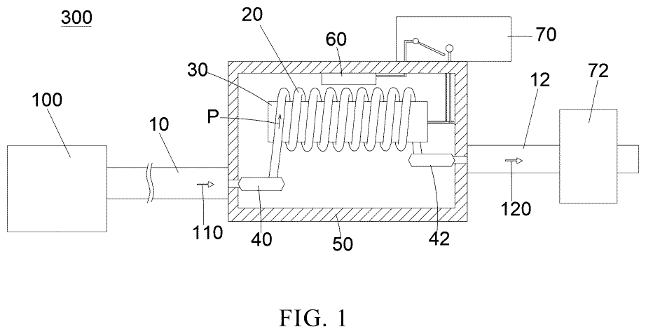

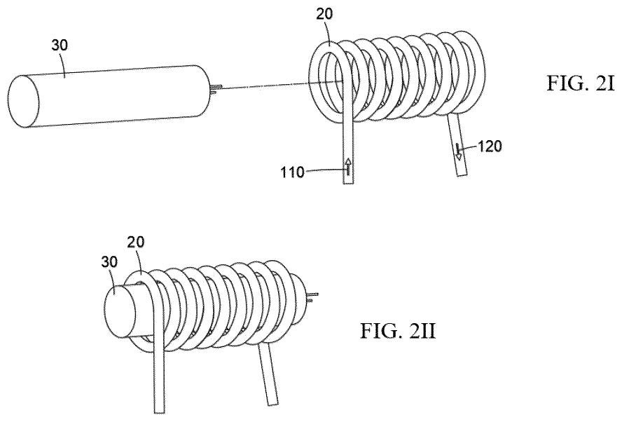

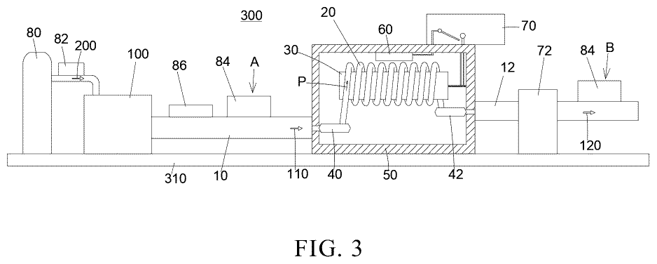

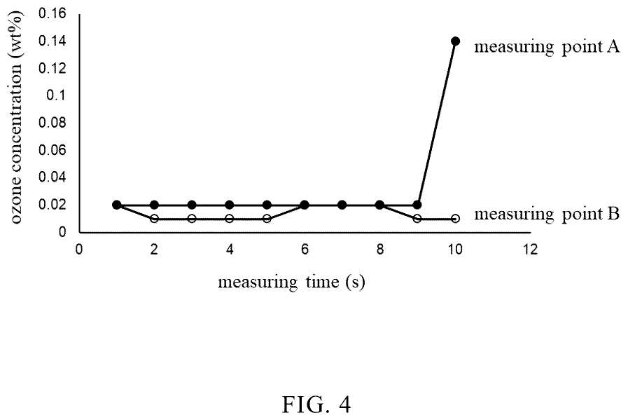

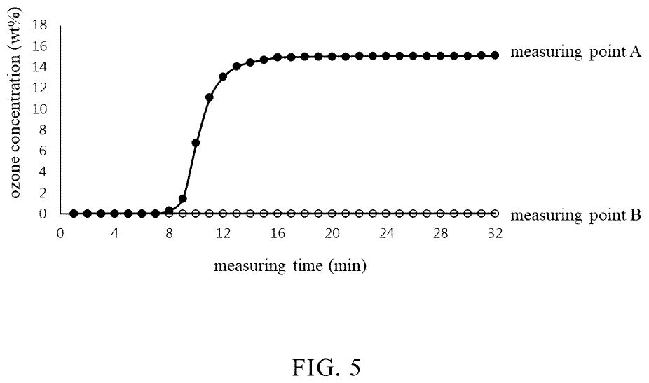

Please refer to FIGS. 1 to 5. FIG. 1 is a schematic diagram of an ozone reduction device of the disclosure. FIG. 2I and FIG. 2II are schematic diagrams of combination of a gas delivery tube and a heating element of the ozone reduction device of the disclosure, in which FIG. 2I is a schematic diagram before assembly, and FIG. 2II is a schematic diagram after assembly. FIG. 3 is a schematic diagram of an ozone reduction experimental equipment used in the ozone reduction device of the disclosure. FIG. 4 is a 10-second measurement chart of an ozone reduction experiment of the ozone reduction device of the disclosure. FIG. 5 is a 30-second measurement chart of the ozone reduction experiment of the ozone reduction device of the disclosure. An ozone reduction device 300 of the disclosure is used to reduce an ozone 110 provided by an ozone source 100 into an oxygen 120. The ozone reduction device 300 of the disclosure comprises a gas inlet duct 10, a gas delivery tube 20, a heating element 30 and a gas outlet duct 12. The gas inlet duct 10 is communicated to the ozone source 100 for introducing the ozone 110 provided by the ozone source 100. The disclosure does not limit type or use of the ozone source 100. For example, the ozone 110 supplied by the ozone source 100 can be applied to clean surfaces of semiconductor wafers, so an amount of the ozone 110 introduced into the gas inlet duct 10 only accounts for a part of an ozone generation amount of the ozone source 100, an amount of the ozone 110 could even be, for example, excess ozone.

The gas delivery tube 20 introduces the ozone 110 provided by the ozone source 100 through the gas inlet duct 10. One of the features of the disclosure is that the gas delivery tube 20 transports the ozone 110 along a spiral delivery path P. The heating element 30 provides a thermal energy to heat the ozone 110 transported by the gas delivery tube 20, so that the ozone 110 is heated by the thermal energy provided by the heating element 30 and reduced to the oxygen 120 when flowing along the spiral delivery path P (that is, during a flow process). In other words, the disclosure uses the gas delivery tube 20 with a hollow spiral structure as an ozone reduction chamber. The ozone 110 can not only flow along the spiral delivery path P inside the gas delivery tube 20 and perform a reduction step, but also avoid contact with the heating element 30. The gas delivery tube 20 is, for example, a spiral tube, such as a spiral quartz tube, and the gas delivery tube 20 is spirally provided on the heating element 30, for example, sleeved on an exterior of the heating element 30.

The heating element 30 of the disclosure is, for example, an electric heater such as a ceramic heating tube, but is not limited thereto. The heating element 30 can also be any conventional heater, such as a resistance heater or a heat exchange heater. The disclosure uses a spiral quartz tube to transport ozone gas, which can increase a contact area (i.e., heat transfer area) between the ozone 110 and a tube wall of the spiral quartz tube to ensure that gas molecules of the ozone 110 flowing into the spiral quartz tube have sufficient heating time to be fully heated, so that the ozone 110 can be fully reduced to the oxygen 120 during a flow process of the ozone 110 along the spiral delivery path P, that is, before the ozone 110 is introduced out of the spiral quartz tube. The disclosure is capable of quickly reducing the ozone 110 to the oxygen 120, so it is very suitable for large-flow ozone gas reduction. In addition, the disclosure is not limited to a specific method of heating the ozone 110. The heating element 30 of the disclosure can optionally directly heat only the ozone 110, simultaneously heat the gas delivery tube 20 and the ozone 110 in the gas delivery tube 20, and/or indirectly heat the ozone 110 in the gas delivery tube 20 by heating the gas delivery tube 20, depending on a material of the gas delivery tube 20 and a heating type of the heating element 30.

The gas outlet duct 12 of the ozone reduction device 300 of the disclosure is communicated to the gas delivery tube 20 to discharge the oxygen 120 obtained by reducing the ozone 110.

In addition, the ozone reduction device 300 of the disclosure further optionally comprises a heat insulation element 50. A purpose of the heat insulation element 50 is to further ensure uniform heating temperature to avoid rapid drop in temperature. Therefore, the heat insulation element 50 can be optionally coated at any appropriate location and on any component, such as coating one or more than one of the gas delivery tube 20, the heating element 30, the gas inlet duct 10 and/or the gas outlet duct 12, thereby maintaining a temperature of heating the ozone 110, for example, so that an interior of the gas delivery tube 20 is maintained at a preset temperature, wherein the preset temperature can, for example, make a temperature of the ozone 110 to reduce to that of the oxygen 120. The heat insulation element 50 of the disclosure is, for example, but not limited to, ceramic fiber thermal insulation foam, and the heat insulation element 50 is not limited to specific size or specification, as long as a thermal insulation effect can be provided, it falls within the scope of protection claimed by the disclosure. The preset temperature is, for example, 350 degrees Celsius, but the disclosure is not limited thereto. Since a half-life of the ozone 110 is inversely related to a temperature, the preset temperature can be set, for example, corresponding to a length of the spiral delivery path P and/or a flow rate of the ozone 110. For example, assuming that a length of the spiral delivery path P is about 276 cm, an inner diameter of the gas delivery tube 20 is about 4 mm, and a diameter of a spiral structure is about 50 mm, when a flow rate of the ozone 110 is about 27 L/min, a time of the ozone 110 stayed in the gas delivery tube 20 is approximately 77 ms. In other words, as long as the ozone 110 is fully reduced to the oxygen 120 or a preset ratio of the ozone 110 is reduced to the oxygen 120 before the ozone 110 is exported out of the ozone reduction device 300 of the disclosure, any specification of the gas delivery tube 20 and its corresponding preset temperature fall within the scope of protection claimed by the disclosure. The above-mentioned preset ratio can be determined according to actual requirements, and the disclosure is not limited to specific values. Furthermore, calculation of time for the ozone 110 to stay in the gas delivery tube 20 adopts the conventional calculation formula of a relationship between speed-distance and time, so it will not be described again herein.

The ozone reduction device 300 of the disclosure further optionally comprises a thermometer 60 and/or a temperature control element 70. The thermometer 60 is used to measure a heating temperature of a thermal energy provided by the heating element 30 for the ozone 110 in the gas delivery tube 20. The temperature control element 70 is used to control the heating element 30 to provide a thermal energy to heat the ozone 110. For example, the temperature control element 70 is electrically connected to the thermometer 60 and the heating element 30, and is used to control the heating element 30 to provide a thermal energy according to a heating temperature measured by the thermometer 60, so as to heat the ozone 110 to the above-mentioned preset temperature. Wherein the thermometer 60 is, for example, placed above a middle section of the gas delivery tube 20 to detect a heating temperature. The temperature control element 70 is, for example, located on an outer side of the heat insulation element 50 to control a heating temperature of the ozone 110. The thermometer 60 and the temperature control element 70 of the disclosure can, for example, adopt conventional temperature sensors and temperature controllers.

The ozone reduction device 300 of the disclosure further optionally comprises a gas inlet end adapter 40 and a gas outlet end adapter 42. The gas inlet end adapter 40 is connected between the gas inlet duct 10 and the gas delivery tube 20, and the gas outlet end adapter 42 is connected between the gas delivery tube 20 and the gas outlet duct 12. Structures of the gas inlet end adapter 40 and/or the gas outlet end adapter 42 are, for example, but not limited to, Teflon coated with stainless steel, for example, a Teflon layer coated with a stainless steel layer.

The ozone reduction device 300 of the disclosure further optionally comprises a cooling device 72 for lowering a temperature of the oxygen 120 discharged from the gas delivery tube 20. The cooling device 72 is, for example, provided on the gas outlet duct 12 or between the gas delivery tube 20 and the gas outlet duct 12. Wherein the cooling device 72 can be disposed at any position, as long as a cooling effect can be achieved, it falls within the scope of protection claimed by the disclosure. The cooling device 72 is, for example, but not limited to air-cooled, liquid-cooled, phase-change or hybrid cooler, as long as a temperature of the oxygen 120 can be reduced, any type of the cooling device 72 falls within the scope of protection claimed by the disclosure.

Please refer to FIGS. 3 to 5. FIG. 3 is a schematic diagram of an ozone reduction experimental equipment used in the ozone reduction device of the disclosure. FIG. 4 is a 10-second measurement chart of an ozone reduction experiment of the ozone reduction device of the disclosure. FIG. 5 is a 30-second measurement chart of the ozone reduction experiment of the ozone reduction device of the disclosure. The disclosure uses an ozone concentration detector 84 to measure ozone concentrations on two sides of the gas delivery tube 20 (for example, measuring point A and measuring point B) respectively, so that an ozone reduction result of the ozone reduction device 300 of the disclosure can be known. For example, in the disclosure, the ozone source 100 is an ozone generator, and the disclosure provides a pure oxygen 200 to the ozone generator through a high-pressure liquid oxygen bottle 80, thereby providing the ozone 110. Moreover, before the ozone 110 enters the gas delivery tube 20 of the ozone reduction device 300, the disclosure uses the temperature control element 70 to enable the gas delivery tube 20 to reach a high temperature in advance. The thermometer 60 displays, for example, about 350 degrees Celsius, and then the ozone 110 enters the gas delivery tube 20 of the ozone reduction device 300 through the gas inlet duct 10. In detail, the ozone 110 enters the gas delivery tube 20 through the gas inlet end adapter 40, a temperature of the gas delivery tube 20 is about 350 degrees Celsius, after the ozone 110 flows through the gas delivery tube 20 at 350 degrees Celsius, the ozone 110 enters the gas outlet duct 12 through the gas outlet end adapter 42. After the above-mentioned reduced gas passes through the cooling device 72, an ozone concentration is measured again by the ozone concentration detector 84 (measuring point B), and then the reduced gas is discharged. In the disclosure, for example, a mass flow controller 82 is used to control a flow rate of the oxygen 200 to 27 L/min, and a pressure controller 86 is used to control a back pressure to 30 Psi (pounds per square inch). The ozone reduction device 300 of the disclosure is, for example, installed on a workbench 310 to perform ozone reduction experiments, but is not limited thereto.

Please refer to FIG. 4. From data shown in FIG. 4, it can be known that when an ozone concentration at measuring point A rapidly increases from 0.02 wt % to 0.14 wt %, the ozone reduction device 300 of the disclosure is capable of reducing 0.14 wt % ozone to a remaining 0.01 wt % (measuring point B) in less than one second.

Please refer to FIG. 5. FIG. 5 shows data of continuously using the ozone reduction device 300 of the disclosure to perform ozone reduction reaction and simultaneously measure ozone concentrations (measuring point A, measuring point B) for 30 minutes. It can be known from FIG. 5 that the ozone reduction device 300 of the disclosure is still capable of maintaining a good reaction even under long-term operation.

In the above ozone reduction experiments, a flow rate of the ozone 110 supplied by the ozone source 100 is about 27 liters per minute, and an ozone concentration is about 15.3 wt % (measuring point A). After conversion, it can be known that there are about 354 grams of ozone per hour, compared with an ozone concentration for general space disinfection and sterilization, it is more than 3 times higher. The disclosure uses the gas delivery tube 20 (such as a spiral quartz tube) to enable the ozone 110 to have enough time to be heated and quickly reduced to the oxygen 120 (the ozone 110 is hardly detected at measuring point B). Moreover, the disclosure is capable of performing ozone reduction stably for a long time by using the heat insulation element 50 (e.g., heat insulation material layer).

Based on the above, the ozone reduction device of the disclosure can have one or more than one of the following advantages:
(1) By using the spiral gas delivery tube, such as a spiral quartz tube, as an ozone reduction chamber, an occupied space is smaller than that of the conventional straight-cylindrical ozone reduction chamber and a heat transfer area can be increased, capable of ensuring that ozone molecules flowing into the spiral gas delivery tube have sufficient heating time.
(2) The gas delivery tube is spirally sleeved on an exterior of the heating element, so that the heating element is located inside the spiral gas delivery tube, capable of providing better heating efficiency than conventional technology, thereby achieving an efficacy of reducing costs.
(3) The use of a heat insulation element is capable of further ensuring uniform heating temperature and avoiding rapid drop in temperature.
(4) Using the spiral gas delivery tube as an ozone reduction chamber is capable of avoiding corrosion of the heating element caused by direct ozone contact with the heating element in conventional technology.
(5) Ozone gas can be quickly reduced to oxygen, so the disclosure is very suitable for using in large-flow ozone gas reduction.

Note that the specification relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. An ozone reduction device for reducing an ozone provided by an ozone source into an oxygen, comprising:
a gas inlet duct communicated to the ozone source;
a gas delivery tube used for introducing the ozone provided by the ozone source through the gas inlet duct, the gas delivery tube transporting the ozone along a spiral delivery path;
a heating element used for providing a thermal energy to heat the ozone transported by the gas delivery tube, so that the ozone being heated by the thermal energy and reduced to the oxygen when flowing along the spiral delivery path; and
a gas outlet duct communicated to the gas delivery tube and used to discharge the oxygen obtained by reducing the ozone.

2. The ozone reduction device as claimed in claim 1, wherein the gas delivery tube is a spiral tube, and the gas delivery tube is spirally provided on the heating element.

3. The ozone reduction device as claimed in claim 1, wherein the gas delivery tube is a spiral quartz tube, and the spiral quartz tube is sleeved on an exterior of the heating element.

4. The ozone reduction device as claimed in claim 1, wherein the heating element directly heats only the ozone in the gas delivery tube, simultaneously heats the gas delivery tube and the ozone in the gas delivery tube, and/or indirectly heats the ozone in the gas delivery tube by heating the gas delivery tube.

5. The ozone reduction device as claimed in claim 1, further comprising a heat insulation element, the heat insulation element coating one or more than one of the gas delivery tube, the heating element, the gas inlet duct and/or the gas outlet duct, thereby maintaining a heating temperature of the ozone.

6. The ozone reduction device as claimed in claim 5, wherein the heat insulation element is a ceramic fiber thermal insulation foam.

7. The ozone reduction device as claimed in claim 1, further comprising a thermometer for measuring a heating temperature of the thermal energy provided by the heating element for the ozone in the gas delivery tube.

8. The ozone reduction device as claimed in claim 7, further comprising a temperature control element for controlling the heating element to provide the thermal energy according to the heating temperature measured by the thermometer, thereby heating the ozone to a preset temperature.

9. The ozone reduction device as claimed in claim 1, further comprising a gas inlet end adapter and a gas outlet end adapter, the gas inlet end adapter being connected between the gas inlet duct and the gas delivery tube, and the gas outlet end adapter being connected between the gas delivery tube and the gas outlet duct.

10. The ozone reduction device as claimed in claim 9, wherein structures of the gas inlet end adapter and/or the gas outlet end adapter are Teflon coated with stainless steel.

11. The ozone reduction device as claimed in claim 1, further comprising a cooling device, the cooling device being provided on the gas outlet duct or between the gas delivery tube and the gas outlet duct for lowering a temperature of the oxygen discharged from the gas delivery tube.

12. The ozone reduction device as claimed in claim 1, wherein the heating element is a ceramic heating tube.
